(19) United States
(12) Patent Application Publication
(10) Pub. No.: US 2026/0220261 A1
(43) Pub. Date: Jul. 30, 2026

(54) SYSTEM AND METHOD FOR BLOCKING AND NOTIFYING A CRUD OPERATION OF A DOWNLOADED FILE

(71) Applicant: IOZ SOT Private Limited, Coimbatore (IN)

(72) Inventor: Guruvishnuvardan Mounagurusamy, Coimbatore (IN)

(21) Appl. No.: 19/147,274

(22) PCT Filed: Jan. 24, 2024
(86) PCT No.: PCT/IN2024/050065

§ 371 Date: Jul. 10, 2025

(30) Foreign Application Priority Data
Jan. 25, 2023 (IN) 202341005106

(51) Int. Cl. G06F 21/55; G06F 9/54

(52) U.S. Cl. CPC G06F 21/554; G06F 9/54

(57) ABSTRACT

A method for configuring a first user device to enable an automatic blocking of at least one downloaded file in the first user device when CRUD operation is initiated by the downloaded file is provided. The method includes configuring the first user device associated with at least one user with an operating system chaining (OSC) server to (i) obtain a request from the first user device, (ii) block a download of the at least one file by detecting the file that is being downloaded on the first user device, (iii) send a first notification to the first user device, (iv) initiate to download the at least one file from the external device to the first user device, (v) block the at least one create, read, update, or delete (CRUD) operation initiated by the at least one file that is downloaded in the first user device.

### BACKGROUND

### Technical Field

The embodiments herein generally relate to security in computer systems, and more particularly, to a system and a method for blocking and notifying a Create, Read, Update, or Delete (CRUD) operation of a downloaded file to prevent a user device from various security threats in real-time. Also, a method for blocking and notifying downloading the file.

### Description of the Related Art

In an internet era, attackers may perform unauthorized actions like zero-day attacks, deploying ransomware, malware, espionage malware from pen drives, password attacks, Domain Name System (DNS) tunneling, Structured Query Language (SQL) injection attacks, etc., in a computer system using software vulnerabilities to breach information of individuals or organizations on computers, servers, and clouds, through the internet. Further, the unauthorized actions weaken the overall security of the computer system mobile devices, or such devices. Hence, a cyber-attack is one of biggest issues for securing information in both government and corporate sectors.

In an existing system, if a file is downloaded into a storage device, a user, or an admin, cannot detect, and delete malicious threats in the file of the storage device of a computer system.

Various conventional systems securely view various data content, like documents, presentations, spreadsheets, emails blog entries, text, etc. using a secure viewing facility. For example, the conventional systems encrypt an email message along with attachments using encryption algorithms when a user sends an email with sensitive content. If the email is intercepted during transit, the email remains unreadable to unauthorized individuals. When a recipient receives the email, the recipient is required to authenticate themselves using their unique login credentials or other secure authentication methods. Once authenticated, the secure viewing facility within the email platform decrypts the email content and displays the email to the recipient in a secure environment. The secure exchange server monitors an authorized user's actions by using a camera and biometric sensor. The secure exchange server permits the data content to be viewed on the computer's display. However, the conventional systems do not block a downloading process of the file or data while sharing the file or the data from one device to another device. Also, the conventional systems do not block create, read, update, or delete operations performed by the downloaded file.

Another existing system monitors activities of a child's smartphone, including texting applications, social media applications, image applications, etc. The existing system accesses and downloads data from the child's smartphone to identify any unauthorized language, images, and websites. However, the existing system does not block a downloading process of the data or files in the child's smartphone. Also, the existing system fails to block create, read, update, and delete (CRUD) operations performed by downloaded files in the child's smartphone.

Accordingly, there remains a need to address the aforementioned technical drawbacks in existing technologies to enhance computer system security in real-time communication actions by implementing specific restrictions on file downloads and subsequent file operations.

### SUMMARY OF THE INVENTION

In view of the foregoing, an embodiment herein provides a method for configuring a first user device to enable an automatic blocking of at least one downloaded file in the first user device when at least one Create, Read, Update, or Delete (CRUD) operation is initiated by the at least one downloaded file is provided. The method includes configuring the first user device associated with at least one user with an operating system chaining (OSC) server to (i) obtain a request from the first user device associated with the at least one user or the second user device associated with an admin to download at least one file in the first user device from an external device, (ii) block a download of the at least one file by detecting the file that is being downloaded on the first user device, (iii) send a first notification to the first user device associated with the at least one user or a second user device associated with the admin based on at least one action code that is selected by the at least one user or admin when the at least one file is blocked from being downloaded on the first user device. The first notification includes a first screenshot of the at least one file that is downloading in the first user device, with one or more selectable options for the user to accept, reject, or hold the at least one file. The at least one action code is a specific identifier that is assigned to a specific action of the user and allows the OSC server to identify and respond to the specific action of the user, (iv) initiate to download the at least one file from the external device to the first user device when the at least one user or admin chooses the accept option from the one or more selectable options through the first notification, (v) block the at least one create, read, update, or delete (CRUD) operation initiated by the at least one file that is downloaded in the first user device.

In some embodiments, the method includes sending a second notification to the first user device of the at least one user or the second user device of the admin based on the at least one action code that is selected by the at least one user or admin when the at least one CRUD operation is blocked in the first user device. The second notification includes a second screenshot with the one or more selectable options for the user to accept, reject, or hold the at least one CRUD operation of the at least one file that is downloaded in the first user device.

In some embodiments, the method includes configuring the first user device associated with at least one user with the operating system chaining (OSC) server by (i) receiving input from the at least one user through the first user device. The input includes at least one of a name of the user, the name of the admin, the mobile number of the user, the mobile number of the admin, a private key, or the at least one action code. The at least one action code selected by the at least one user or admin from one or more action codes, (ii) generating an encrypted globally unique identifier (GUID) for the input of the at least one user or admin, (iii) sending the encrypted GUID to the first user device associated with the at least one user or the second user device of the admin based on the at least one action code selected by the user through a third notification. The third notification includes the one or more selectable option codes, allowing the at least one user to choose at least one accept, reject or hold the third notification, (iv) validating, by a first cryptone submodule of the first user device, the third notification to decrypt the GUID by analyzing whether the first user device is associated with the at least one user or the second user device is associated with the admin receives the third notification within range of time from the OSC server, (v) sending, by the first user device, the decrypted GUID along with an option code that is selected by the user from the one or more selectable option codes to the OSC server, (vi) mapping, by a second cryptone submodule of the OSC server, a position of the option code in the decrypted GUID. The position may be accepted, hold, or rejected, and (vii) configuring the first user device associated with at least one user or admin with the OSC server by adding the decrypted GUID with the first user device if the OSC server (110) identifies the position as accepted.

In some embodiments, the method includes generating, using a randomization method, at least one first color code for the user and a second color code for the admin based on the encrypted GUID.

In some embodiments, the method includes decrypting the GUID by automatically matching a third color code with the at least one first color code of the user or second color code of the admin. The third color code is automatically generated using the randomization method by the first user device.

In some embodiments, the encrypted GUID is generated based on a random selection of time zone alphanumeric with respective the mobile number of the at least one user or admin, random color codes, and numbers. The time zone is randomly selected from different time zones by the OSC server using a cryptone algorithm.

In some embodiments, the method includes copying stored files in the first user device from an original space of the stored files to a kernel space of the first user device when the at least one CRUD operation is initiated by the at least one file that is downloaded in the first user device.

In some embodiments, the method includes deleting the copy of the stored files from the kernel space of the first user device when the at least one user or admin accepts the second notification through the first user device.

In some embodiments, the method includes restoring the copy of the stored files from the kernel space of the first user device to the original space of the stored files in the first user device when the at least one user or admin rejects the second notification through the first user device.

In one aspect, a system for configuring a first user device to enable an automatic blocking of at least one downloaded file in the first user device when at least one Create, Read, Update, or Delete (CRUD) operation is initiated by the at least one downloaded file. The system includes an operating system chaining (OSC) server incommunicatively configured to the first user device. The OSC server includes a memory that a set of instructions, and a processor. The processor executes the set of instructions from the memory. The processor is configured to (i) obtain a request from the first user device associated with the at least one user or the second user device associated with an admin to download at least one file in the first user device from an external device, (ii) block a download of the at least one file by detecting the file that is being downloaded on the first user device, (iii) send a first notification to the first user device associated with the at least one user or a second user device associated with the admin based on at least one action code that is selected by the at least one user or admin when the at least one file is blocked from being downloaded on the first user device. The first notification includes a first screenshot of the at least one file that is downloading in the first user device, with one or more selectable options for the user to accept, reject, or hold the at least one file. The at least one action code is a specific identifier that is assigned to a specific action of the user and allows the OSC server to identify and respond to the specific action of the user, (iv) initiate to download the at least one file from the external device to the first user device when the at least one user or admin chooses the accept option from the one or more selectable options through the first notification, (v) block the at least one create, read, update, or delete (CRUD) operation initiated by the at least one file that is downloaded in the first user device.

In some embodiments, the processor is configured to send a second notification to the first user device of the at least one user or the second user device of the admin based on the at least one action code that is selected by the at least one user or admin when the at least one CRUD operation is blocked in the first user device. The second notification includes a second screenshot with the one or more selectable options for the user to accept, reject, or hold the at least one CRUD operation of the at least one file that is downloaded in the first user device.

In some embodiments, the processor configures the first user device associated with at least one user with the operating system chaining (OSC) server by (i) receiving input from the at least one user through the first user device. The input includes at least one of a name of the user, the name of the admin, the mobile number of the user, the mobile number of the admin, a private key, or the at least one action code. The at least one action code selected by the at least one user or admin from one or more action codes, (ii) generating an encrypted globally unique identifier (GUID) for the input of the at least one user or admin, (iii) sending the encrypted GUID to the first user device associated with the at least one user or the second user device of the admin based on the at least one action code selected by the user through a third notification. The third notification includes the one or more selectable option codes, allowing the at least one user to choose at least one accept, reject or hold the third notification, (iv) validating, by a first cryptone submodule of the first user device, the third notification to decrypt the GUID by analyzing whether the first user device is associated with the at least one user or the second user device is associated with the admin receives the third notification within range of time from the OSC server, (v) sending, by the first user device, the decrypted GUID along with an option code that is selected by the user from the one or more selectable option codes to the OSC server, (vi) mapping, by a second cryptone submodule of the OSC server, a position of the option code in the decrypted GUID. The position may be accepted, hold, or rejected, and (vii) configuring the first user device associated with at least one user or admin with the OSC server by adding the decrypted GUID with the first user device if the OSC server (110) identifies the position as accepted.

In some embodiments, the processor is configured to generate, using a randomization method, at least one first color code for the user and a second color code for the admin based on the encrypted GUID.

In some embodiments, the processor is configured to decrypt the GUID by automatically matching a third color code with the at least one first color code of the user or second color code of the admin. The third color code is automatically generated using the randomization method by the first user device.

In some embodiments, the encrypted GUID is generated based on a random selection of time zone alphanumeric with respective the mobile number of the at least one user or admin, random color codes, and numbers. The time zone is randomly selected from different time zones by the OSC server using a cryptone algorithm.

In some embodiments, the processor is configured to copy stored files in the first user device from an original space of the stored files to a kernel space of the first user device when the at least one CRUD operation is initiated by the at least one file that is downloaded in the first user device.

In some embodiments, the processor is configured to delete the copy of the stored files from the kernel space of the first user device when the at least one user or admin accepts the second notification through the first user device.

In some embodiments, the processor is configured to restore the copy of the stored files from the kernel space of the first user device to the original space of the stored files in the first user device when the at least one user or admin rejects the second notification through the first user device.

In another aspect, there is provided one or more non-transitory computer-readable storage mediums storing one or more sequences of instructions, which when executed by one or more processors, cause a method for configuring a first user device to enable an automatic blocking of at least one downloaded file in the first user device when at least one Create, Read, Update, or Delete (CRUD) operation is initiated by the at least one downloaded file is provided. The method includes configuring the first user device associated with at least one user with an operating system chaining (OSC) server to (i) obtain a request from the first user device associated with the at least one user or the second user device associated with an admin to download at least one file in the first user device from an external device, (ii) block a download of the at least one file by detecting the file that is being downloaded on the first user device, (iii) send a first notification to the first user device associated with the at least one user or a second user device associated with the admin based on at least one action code that is selected by the at least one user or admin when the at least one file is blocked from being downloaded on the first user device. The first notification includes a first screenshot of the at least one file that is downloading in the first user device, with one or more selectable options for the user to accept, reject, or hold the at least one file. The at least one action code is a specific identifier that is assigned to a specific action of the user and allows the OSC server to identify and respond to the specific action of the user, (iv) initiate to download the at least one file from the external device to the first user device when the at least one user or admin chooses the accept option from the one or more selectable options through the first notification, (v) block the at least one create, read, update, or delete (CRUD) operation initiated by the at least one file that is downloaded in the first user device.

A system for configuring a user device to enable an automatic blocking of at least one downloaded file in the user device when at least one Create, Read, Update, or Delete (CRUD) operation is initiated by the downloaded file. The system blocks and notifies the CRUD operation of the downloaded file to the mobile number of both user and admin in real-time. The system ensures that potentially malicious or unauthorized files do not compromise the user device protects against potential security threats and prevents unauthorized access or modifications to files. The system provides real-time notifications to both the user and the admin when a file download is initiated and when CRUD operations are performed on the downloaded file. This immediate alerting mechanism enables prompt action against unauthorized activities, allowing for swift response and mitigation of potential security risks.

The system receives a dual validation from both the admin and the user by selecting an action code during a configuration of the user device with the OSC server, thereby preventing a user device from various security threats. The system does not require any new software installation to protect the file system from cyber-attacks such as destroying and stealing the file system, as the user device is securely configured with the OSC server and it is cost-effective. By blocking and notifying the downloading process in real-time, the system prevents unauthorized files from reaching the user device, reducing the risk of data breaches, or other security incidents and ensuring that potentially harmful files are intercepted before they can cause any damage.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a system for configuring a first user device to enable an automatic blocking of downloaded file in the first user device when create, read, update, or delete (CRUD) operation is initiated by the downloaded file according to some embodiments herein;

FIG. 2 is a block diagram that illustrates the Operating System Chaining (OSC) server of FIG. 1 according to some embodiments herein;

FIG. 3 is a block diagram that illustrates the configuration of the Operating System Chaining (OSC) server with the user device of FIG. 1 according to some embodiments here;

FIG. 4 block diagram of one or more sub-modules of the encrypted GUID generating submodule of FIG. 2 according to some embodiments herein;

FIG. 5 is a block diagram that illustrates one or more modules of the user device for blocking and notifying a CRUD operation of a downloaded file according to some embodiments herein;

FIG. 6 is an exemplary diagram that illustrates a file downloading from cloud storage to the first user device in accordance with some embodiments herein;

FIG. 7 is an exemplary diagram that illustrates the first user device is connected to one or more user devices to send a notification to one or more users in accordance with some embodiments herein;

FIG. 8 is an exemplary diagram that illustrates a process map of a downloaded file in the first user device in accordance with some embodiments herein;

FIG. 9 is an exemplary user interface view of the input receiving submodule of FIG. 2 which displays one or more action codes in accordance with the embodiments herein;

FIG. 10 is an exemplary user interface view of the first notification of downloading file that is sent to the user of FIG. 1 in accordance with some embodiments herein;

FIG. 11 is an exemplary user interface view of the second notification of downloading file that is sent to the admin of FIG. 1 in accordance with some embodiments herein;

FIG. 12 is a flow diagram that illustrates a method for configuring a first user device to enable an automatic blocking of a downloaded file in the first user device when create, read, update, or delete (CRUD) operation is initiated by the downloaded file in accordance with some embodiments herein; and

FIG. 13 is a schematic diagram of a computer architecture in accordance with the embodiments herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for an improved approach to protecting data from various threats by blocking and notifying a Create, Read, Update or Delete (CRUD) operation of a downloaded file.

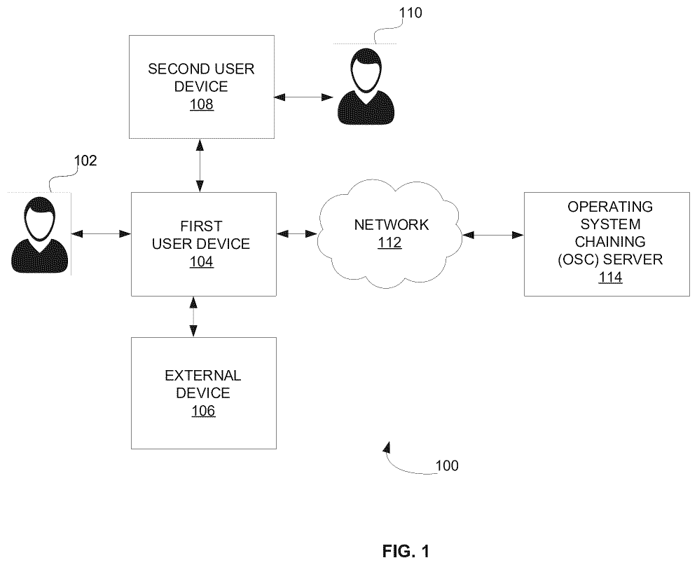

Referring now to the drawings, and more particularly to FIGS. 1 through 13, where similar reference characters denote corresponding features consistently throughout the figures, preferred embodiments are shown.

FIG. 1 is a block diagram that illustrates a system 100 for configuring a first user device to enable an automatic blocking of a downloaded file in the first user device when create, read, update, or delete (CRUD) operation is initiated by the downloaded file according to some embodiments herein. The system 100 includes the first user device 104 associated with a user 102, a second user device 108 associated with an admin 110, an external device 106, and an Operating System Chaining (OSC) server 114. The first user device 104 and the second user device 108 may include but are not limited to, a mobile phone, a tablet, a Personal computer, a laptop, a server, automobiles, or Internet of Things (IoT) devices. The first user device 104 is communicatively connected with the OSC server 114 through a network 112. The network 112 may be a combination of a wired network or a wireless network. The network 112 may be an Internet. The OSC server 114 includes a memory that stores a database and a set of instructions that further includes a processor in communication with the memory and the processor retrieving and executing machine-readable program instructions from the memory. The first user device 104 initiates to download a file from the external device 106 to the first user device 104. In some embodiments, the downloading process of the file is automatically initiated by the first user device 104 or manually initiated by the user 102 through the first user device 104 from the external device 106 to the first user device 104. For example, the external device 106 may be, a pen drive, universal serial bus (USB), compact disc, laptop, mobile phone, a cloud, etc. The external device 106 may be associated with a storage device, but it is not limited to a hard Disk Drive (HDD), Solid-State Drive (SSD), Cloud or Random-Access Memory (RAM), etc. The file may be any type of document, an image, a video, audio, software, etc. The first user device 104 associated with the user 102 is configured with the OSC server 114. The first user device 104 includes various storage devices, such as but not limited to hard disk drives (HDDs), solid-state drives (SSDs), cloud storage, and random-access memory (RAM) that includes a diverse array of formats. The diverse array of formats may include PDF, documents, spreadsheets, images, videos, audio files, software, and commands of the system 100. The diverse array of formats may be internal storage components, which means the diverse array of formats that could be present on or interact with the first user device 104 in different scenarios. The different scenarios may be normal usage, potential security threats, or specific software applications being run.

The OSC server 114 receives a request from the user 102 to download the file in the first user device 104 from the external device 106. In some embodiments, the user 102 or the admin 110 has requested the OSC server 114 through the second user device 108 to download the file or multiple files onto the first user device 104. The OSC server 114 blocks the file that is downloading onto the first user device 104 when the file transfer is initiated from the external device 106 to the first user device 104. For example, when someone tries to download the file from the external device 106 to the first user device 104 of the user 102, the OSC server 114 intervenes and blocks the download of the file.

The OSC server 114 blocks the download of the file by detecting the file that is being downloaded on the first user device 104. In some embodiments, the OSC server 114 actively monitors the first user device 104 and identifies a specific file that is in a process of being downloaded. Once the file is detected, the OSC server 114 blocks the file is being downloaded. The OSC server 114 automatically notifies the file that is being downloaded on the first user device 104 to a mobile number of the user 102 or the admin 110 as a first notification based on an action code that is selected by the user 102 or the admin 110 when the file is blocked from being downloaded on the first user device 104. The first notification includes a first screenshot with one or more selectable options for the user 102 or the admin 110 to accept, reject, or hold the downloading of the file. The action code is a specific identifier that is assigned to a specific action of the user 102 and allows the OSC server 114 to identify and respond to the specific action of the user 102.

The OSC server 114 initiates downloading of the file from the external device 106 to the first user device 104 when the user 102 or the admin 110 accepts the first notification from the one or more selectable options through the first notification. The OSC server 114 automatically blocks the create, read, update, or delete (CRUD) operation initiated by the file that is downloaded in the first user device 104.

In some embodiments, the OSC server 114 blocks the command that is given to a computer's operating system to perform specific tasks, configurations, or actions by the user 102 or the admin 110. The command is entered through a command-line interface (CLI), and the command allows users to interact with the operating system directly. The command may be managing file directories, configuration details, security and permissions, backup and storage, or troubleshooting.

In some embodiments, the first user device 104 validates a new connection through the OSC server 114 when the new connection is initiated to download from the external device 106. The new connection may be Bluetooth connection, Wi-Fi connection, microwave, light, laser, millimeter (MMWAVE), any form of the internet like Local Area Network (LAN), Wide Area Network (WAN), and any form of electromagnetic waves.

For example, the OSC server 114 can be configured in automobile applications. The OSC server 114 automatically blocks software upgrades if a vehicle is in moving condition and at the same time, the OSC server 114, notifies software upgrades that are being downloaded on the vehicle to the mobile number of the user 102 or the admin 110 through Over the air update (OTA) with the option of ACCEPT, REJECT, HOLD. In some embodiments, the OSC server 114 blocks a process of loading code directly into the random-access memory (RAM) of the first user device 104 and sends a notification to the user 102 or the admin 110 based on the action code that is selected by the user 102 or the admin 110 when the malicious code starts to load on the RAM of the first user device 104.

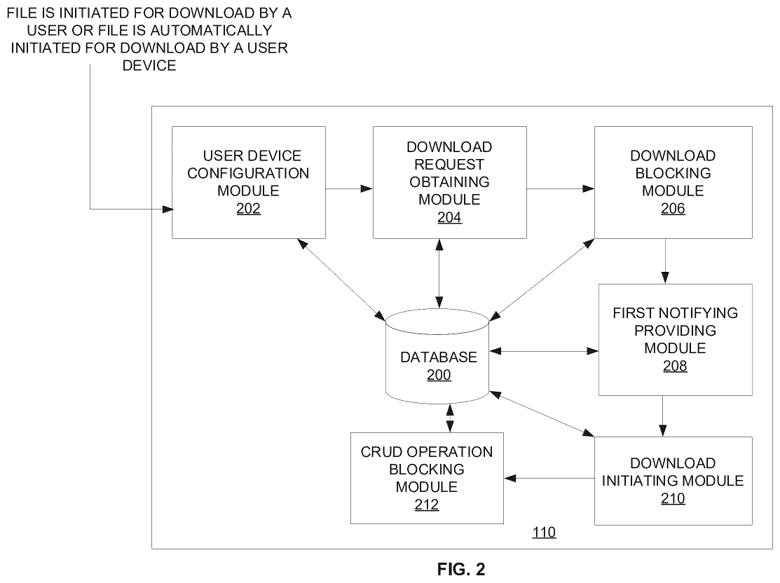

FIG. 2 is a block diagram that illustrates the Operating System Chaining (OSC) server 114 of FIG. 1 according to some embodiments herein. The OSC server 114 includes a user device configuration module 202, a download request obtaining module 204, a download blocking module 206, a first notification providing module 208, a download initiating module 210, a CRUD operation blocking module 212, and a database 200. The database stores a set of instructions.

The user device configuration module 202 configures the first user device 104 with the OSC server 114. The download request obtaining module 204 obtains a request from the user 102 or the admin 110 to download the file in the first user device 104 from the external device 106. The download blocking module 206 blocks the downloading of the file by detecting the file that is being downloaded on the first user device 104. The first notification providing module 208 sends the first notification to the mobile number of the user 102 or the admin or the first user device 104 of the user 102 or the admin based on the action code that is selected by the user 102 or the admin when the file is blocked from being downloaded on the first user device 104. The first notification includes the first screenshot of the file that is being downloaded on the first user device 104, with one or more selectable options for the user to accept, reject, or hold the file. The action code is a specific identifier that is assigned to a specific action of the user 102 and allows the OSC server 114 to identify and respond to the specific action of the user 102.

The download initiating module 210 initiates to download of the file from the external device 106 to the first user device 104 when the user 102 or the admin chooses the accept option from the one or more selectable options through the first notification. The CRUD operation blocking module 212 blocks the Create, Read, Update, or Delete (CRUD) operation initiated by the file that is downloaded in the first user device 104.

For example, in a solar wind attack, attackers might have used a spear-phishing email. The spear-phishing email is a targeted form of phishing where the attackers send emails to specific individuals or organizations. The spear-phishing email contained malicious code to exploit either a known vulnerability or a zero-day vulnerability. The OSC server 114 blocks an execution of the CRUD operations of any downloaded file or new connection. Additionally, the OSC server 114 alerts the user 102, admin, super admin, or security operations center (SOC), to any attempts at inserting malicious code as part of the CRUD operation.

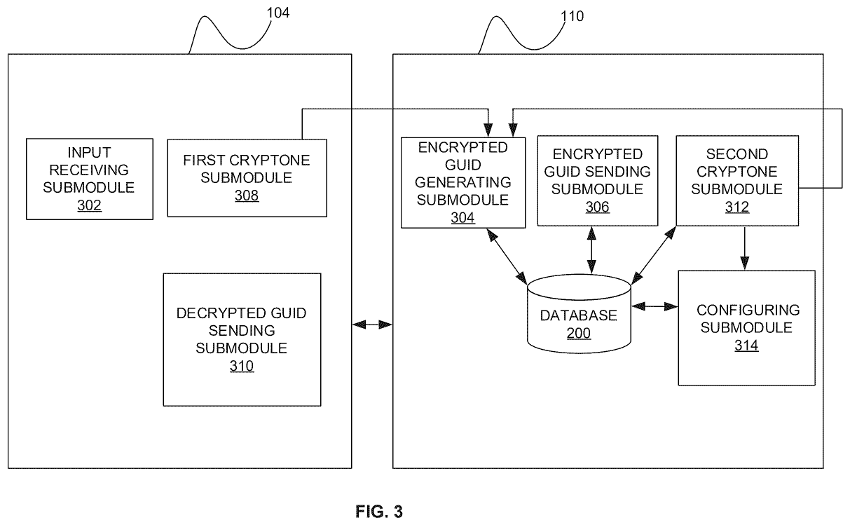

FIG. 3 is a block diagram that illustrates the configuration of Operating System Chaining (OSC) server 114 with the first user device 104 of FIG. 1 according to some embodiments herein. The first user device 104 includes an input-receiving submodule 302, a first cryptone submodule 308, and a decrypted GUID sending submodule 310. The OSC server module 110 includes an encrypted GUID generating submodule 304, an encrypted GUID sending submodule 306, a second cryptone submodule 312, a configuring submodule 314, and the database 200 that stores the set of instructions.

The input-receiving submodule 302 receives input from the user 102 or the admin 110 through the first user device 104 to register the user 102 and the admin 110 in the Operating System Chaining (OSC) server 114. The input includes a name of the user 102, the name of the admin, the mobile number of the user 102, the mobile number of the admin, a private key, or the action code. The action code is selected by the user 102 or the admin 110 from one or more action codes. For example, the name of the first user device 104 may be ABC_1344234666. The user 102 selects the action code from the one or more action codes that are prompted by OSC server 114 through the first user device 104. Accordingly, the OSC server 114 determines whether the user 102 or the admin 110 should receive a short message service (SMS) or push notification, peer-to-peer messaging, or Internet Messaging and who should valid the SMS, or the push notification, the peer-to-peer messaging, or the Internet Messaging (i.e.), the OSC server 114 gets the recipient of the SMS and validators of the SMS, For example, if the action code is code 0 and code 1, the OSC server 114 may use the code 0 and code 1 to identify the user 102 and the admin 110 who is authorized to receive a notification related to the downloading files and the OSC server 114 send a notification to both the user 102 and the admin 110 to validate the SMS while the file is initiated for downloading in the first user device 104, (i.e.) the code 0 may represent the user 102 for notifying downloading files, and the code 1 may represent the admin for notifying the downloading files. The OSC server 114 receives a private key for both the user 102 and the admin 110 from the user 102 to enable the first user device 104 to configure with OSC server 114 for blocking and notifying the file that is being downloaded in the first user device 104 and the CRUD operations of the downloaded file. In some embodiments, the user 102 is only able to modify a private key during an initial system configuration of the first user device 104 with the OSC server 114, while the admin may add a temporary private key for the user 102. The admin 110 can also modify configurations of the first user device 104 with the OSC server 114.

The encrypted GUID generating submodule 304 generates the encrypted GUID based on the input of the user 102 or the admin 110 for the user 102, or the admin 110 based on the action code selected by the user 102 or the admin 110. In some embodiments, if the user 102 or the admin 110 selects the code 0 and the code 1 from the one or more action codes, the OSC server 114 generates the encrypted GUID for both the user 102 and the admin 110. For example, the encrypted GUID generated for the user 102 is 2023011423105290942049982X552556879 and the encrypted GUID generated for the admin is 202301141310529094204998255255687X9.

In some embodiments, the GUID is encrypted using a Public Key Infrastructure (PKI). The Public Key Infrastructure (PKI) is a set of policies that are used to secure communications between a sender and receiver by providing a secure method of exchanging information using public key encryption or private key encryption. The PKI enables a secure exchange of data using a public and a private key that is obtained and shared through a trusted authority. The trusted authority may be the user 102 or the admin 110.

The encrypted GUID sending submodule 306 sends the encrypted GUID to the mobile number of the user 102 or the admin 110 through a third notification using a peer-to-peer (P2P) network based on the action code selected by the user 102 or the admin 110. This process is triggered by the user 102 or the admin 110 by selecting the action code during the registration process of the input in the input-receiving sub-module 302. In some embodiments, if the user 102 or the admin 110 selects the “code 0” and the “code 1”, the OSC server 114 maps the code 0 with the encrypted GUID of the user 102, and the encrypted GUID is mapped to the mobile number of the user 102, as well as the OSC server 114 maps the code 1 with the encrypted GUID of the admin and the encrypted GUID is mapped to the mobile number of the admin 110. For example, the OSC server 114 sends the encrypted GUID as 20230114231052909420499825520556879 to the user 102 and at the same time, the OSC server 114 sends the encrypted GUID as 20230114131052909420499825525568719 to the admin 110. This mapping process creates a secure link between the first user device 104 and the OSC server 114 for secure communication. The encrypted GUID provides an additional layer of security, as the encrypted GUID would be difficult for the attacker to intercept and decrypt the communication without a proper decryption key. Further, the OSC server 114 generates a first color code for the user 102 and a second color code for the admin 110 based on the encrypted GUID using a randomization method.

In some embodiments, the OSC server 114 sends the encrypted GUID along with one or more options of ACCEPT, REJECT, or HOLD as a third notification by mapping the action code with the encrypted GUID of the user 102 and the admin 110, if the user 102 selects the code 0 and the code 1 from the one or more action codes. The one or more options are related to one or more option codes. For example, option code 1 represents the option ACCEPT, option code 2 represents the option HOLD, and option code 3 represents the option REJECT. The first cryptone submodule 308 validates the third notification by analyzing whether the mobile number of the user 102 or the admin 110 receives the third notification within sixty seconds from the OSC server 114.

The first user device 104 may call the first cryptone submodule 308 to validate the authenticity of the third notification of the encrypted GUID by checking whether the mobile number of the user 102 or the admin 110 receives the SMS within sixty seconds time constraint from the OSC server 114 to decrypt the GUID decrypting the encrypted GUID. Implementing the time constraint on the SMS is the security measure that makes the encrypted GUID more difficult for the attacker to intercept and respond to the notification within the time frame, as the time constraint is an additional layer of security to the first user device 104 and the OSC server 114. In some embodiments, the first cryptone submodule 308 monitors a time of receipt of the SMS or the third notification. If the OSC server 114 fails to send the SMS or the third notification within sixty seconds, the first cryptone submodule 308 discards a previous SMS and sends a new SMS or new encrypted GUID to the mobile number of the user 102 or the admin 110 using the encrypted GUID generating submodule 304 of the OSC server 114 based on the action code is selected by the user 102 in the input receiving submodule 302. The first cryptone submodule 308 identifies a position of code (i.e., marked as “x” underlined) in the encrypted GUID of the user when “X” is converted to code 0 and the first cryptone submodule 308 identifies a position of the code (i.e., marked as “x” underlined) in the encrypted GUID of the admin when “X” is converted to code 1 while mapping the action code that is selected by the user 102 or the admin 110, with the encrypted GUID of the user 102 and the admin 110.

Further, the first user device 104 decrypts the GUID by automatically matching a third color code with the first color code of the user 102 or a second color code of the admin 110. The third color code is automatically generated using the randomization method by the first user device 104. The decrypted GUID sending submodule 310 sends the validated decrypted GUID with the option code to the OSC server 114 after being validated by the first cryptone submodule 308, to initiate, hold, or reject the configuration of the first user device 104 and the OSC server 114. The option code is selected from the one or more option codes by the user 102. For example, the encrypted GUID of the user 102 is 20230114231052909420499825521556879 and the encrypted GUID of the admin is 20230114231052909420499825522556879. The bolded position 1 represents the user 102 and the bolded position 2 represents the admin.

The second cryptone module 312 detects the position of the option code in a validated decrypted GUID. The OSC server 114 is configured with the first user device 104 based on the option code read by the second cryptone module 312. For example, if the user 102 selects option code 2, the OSC server 114 may interact with the first user device 104 until the user 102 accepts the third notification of the encrypted GUID of the user 102 or the admin which means configuring the first user device 104 with the OSC server 114. The configuring module 312 configures the first user device 104 associated with the user 102 or the admin 110 with the OSC server 114 by adding the decrypted GUID with the user device if the OSC server identifies the position as accepted.

The encrypted GUID sending submodule 306 sends a second encrypted GUID as a fourth notification to the mobile number of the user 102 or the admin 110 or to the first user device 104 of the user 102 or the second user device 108 of the admin 110 if the third notification of the first color code of the user 102 and the admin is not valid or the first color code of the user 102 or the admin 110 does not match with the second color code or the third notification is not received within sixty seconds from the OSC server 114 to the first user device 104. The second encrypted GUID is generated using the encrypted GUID generating submodule 304. In some embodiments, the OSC server 114 sends an encrypted acknowledgment with the cryptone to the mobile number of the user 102 or the admin 110 when the OSC server 114 is configured with the first user device 104.

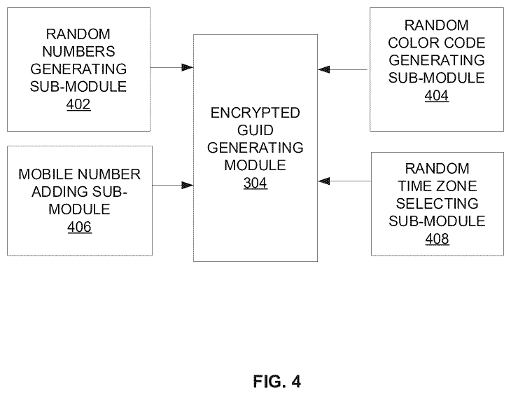

FIG. 4 block diagram of one or more sub-modules of the encrypted GUID generating submodule 304 of FIG. 2 according to some embodiments herein. The operating system chaining (OSC) server 114 includes the encrypted GUID generating submodule 304 that includes random numbers generating submodule 402, a random color code generating submodule 404, a mobile number adding submodule 406, and a random time zone selecting submodule 408. The random numbers generating submodule 402 generate random numbers to create the encrypted GUID. The time zone selecting submodule 408 selects a random time zone while generating the encrypted GUID. The random color code generating submodule 404 generates a first color code for the user 102 and a second color code for the admin 110 based on the encrypted GUID using a randomization method while generating the encrypted GUID. The mobile number adding submodule 406 adds the mobile number while generating the encrypted GUID. The encrypted GUID is generated based on a random selection of the time zone, an alphanumeric, a random selection of color code, and the mobile number of the user, or the admin. For example, the encrypted GUID generated for the user 102 is 2023011423105290942049982X552556879 and the encrypted GUID generated for the admin 110 is 202301141310529094204998255255687X9. The encrypted GUID of the first eight digits “20230114” defines the date, the next 4 digits “2310” define the time zone, and the remaining digits are random number formats, The OSC server 114 selects the time zone from different time zone to generate the encrypted GUID using a cryptone algorithm. For example, the cryptone algorithm randomly selects the time zone for the user 102 and admin 110 from Easternmost Time Zone in the United States (ESTUS) at 23:10, Greenwich Mean Time (GMT) at 04:10, and Japan Standard Time (JST) at 13:10 to generate the encrypted GUID for the user 102 and the admin 110. In some embodiments, the cryptone algorithm may implement the different time zones along with the random number format. The time zone may include a date, an hour, a minute, a second, a millisecond, and a microsecond. The encrypted GUID may be a 32-digit number that is stored in an encrypted kernel space of the OSC server 114 or cloud.

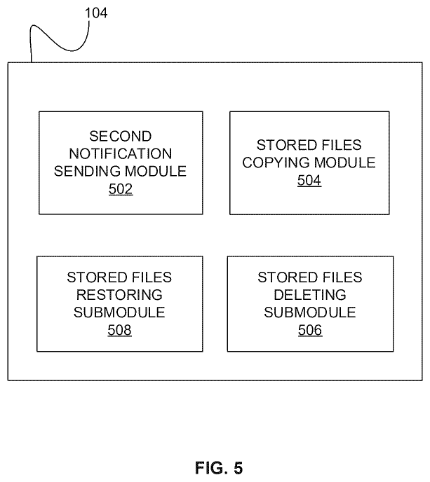

FIG. 5 is a block diagram that illustrates one or more modules of the first user device 104 for blocking and notifying a CRUD operation of a downloaded file according to some embodiments herein. The first user device 104 includes a second notification sending module 502, stored files copying module 504, stored files deleting module 506, and stored files restoring module 508. The second notification sending module 502 sends a second notification to the mobile number of the user 102 or the admin 110 or to the first user device 104 of the user 102 or the second user device 108 of the admin 110 based on the action code when the CRUD operation of the file that is downloaded in the first user device 104 is blocked. The second notification includes a second screenshot with the one or more selectable options for the user 102 to accept, reject, or hold the CRUD operations. The stored files copying module 504 copies stored files in the first user device 104 from an original space of the stored files to a kernel space of the first user device 104 when the CRUD operation is initiated by the file that is downloaded in the first user device 104. The stored files deleting module 506 deletes the copy of the stored files from the kernel space of the first user device 104 when the user 102 or the admin 110 accepts the second notification through the first user device 104. The stored files restoring module 508 restores the copy of the stored files from the kernel space of the first user device 104 to the original space of the stored files in the first user device 104 when the user 102 or the admin 110 rejects the second notification through the first user device 104. In some embodiments, the first user device 104 deletes the downloaded file in the stored files if the user 102 or the admin 110 rejects the second notification through the first user device 104 while restoring the stored files.

In some embodiments, the first user device 104 automatically detects the downloaded file from any medium such as a USB device, network, electromagnetic waves like Bluetooth, Wi-Fi, laser, microwaves, or any future communication methods, etc. For example, if the operating system of the first user device 104 may have 10% of a total disk space, the first user device 104 occupies the space of about 1% for a backup or the copy of the first file system of the first user device 104. In some embodiments, the operating system chaining (OSC) may include a Dynamic Link Library (DLL) or an equivalent DLL. The DLL configures both the OSC server 114 and the OSC client submodule of the first user device 104 for temporary transferring and storing of data.

When the downloaded file 802 is stored in the disk or RAM of the first user device 104, the downloaded file 802 triggers the initiation of one or more subprocesses (i.e., start CRUD operations on files within the disk. The OSC server 114 blocks all these subprocesses and provides a comprehensive process map to the configured user devices. The users, admin, or a Security Operations Center (SOC) have the option to apply accept, reject, or hold on to all processes collectively. The users, admin, or SOC personnel scrutinizes screenshots of the subprocess and make specific decisions (accept/reject/hold) based on their examination. If the downloaded file 802 initiates CRUD operations and the count of such files initiating CRUD operations is less than 5, all processes will be blocked and the second notification will be sent to the configured user devices. However, if the count exceeds 5, a blanket block is enforced on all processes attempting CRUD operations on the user device for a predefined period. Simultaneously, the configured user devices are notified with screenshots of the downloaded files, prompting users, admin, or SOC personnel to closely inspect the unusual behaviour. This proactive approach allows for managing of malicious or undesirable processes on the first user device 104.

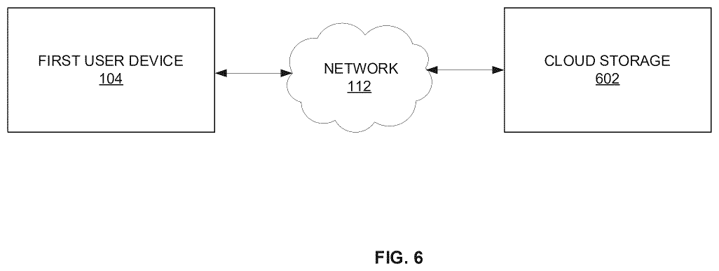

FIG. 6 is an exemplary diagram that illustrates a file downloading from cloud storage to the first user device in accordance with some embodiments herein. The exemplary diagram depicts the cloud storage at 602 transfer or share the file the first user device 104 through the network at 112. The OSC server 114 blocks the file being downloaded from the cloud storage 602 to the first user device 104. Upon initiation of the file download to the first user device 104, the OSC server 114 sends the first notification to alert the first user device 104 of the ongoing download process.

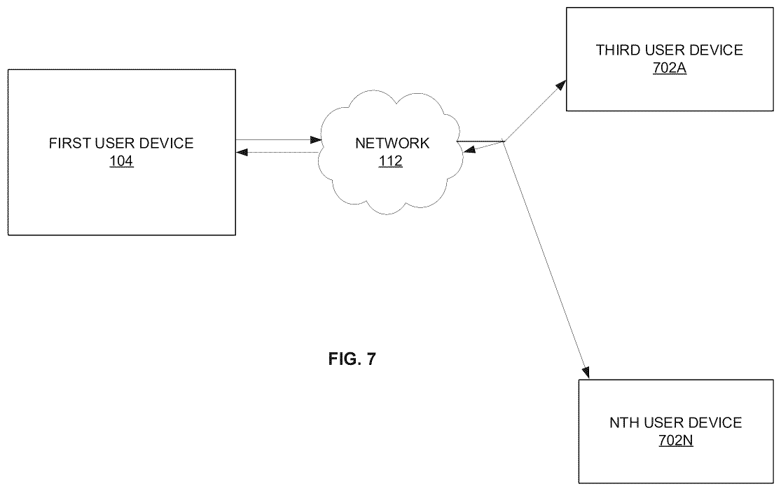

FIG. 7 is an exemplary diagram that illustrates the first user device is connected to one or more user devices to send a notification to one or more users in accordance with some embodiments herein. The exemplary diagram depicts the first user device at 104 is connected to one or more user devices at 702A-N through the network at 112. When the file download is initiated on the first user device 104, the OSC server 114 triggers the transmission of the first notification to the one or more user devices 702A-N. This first notification is used to alert the associated one or more user devices 702A-N about the ongoing download process, based on an action code selected either by the user 102 or the administrator 110 in instances where the file is blocked from being downloaded on the first user device 104. Subsequently, the one or more user devices 702A-N have an option to accept, reject, or temporarily hold the received the first notification to download the file in the first user device 104.

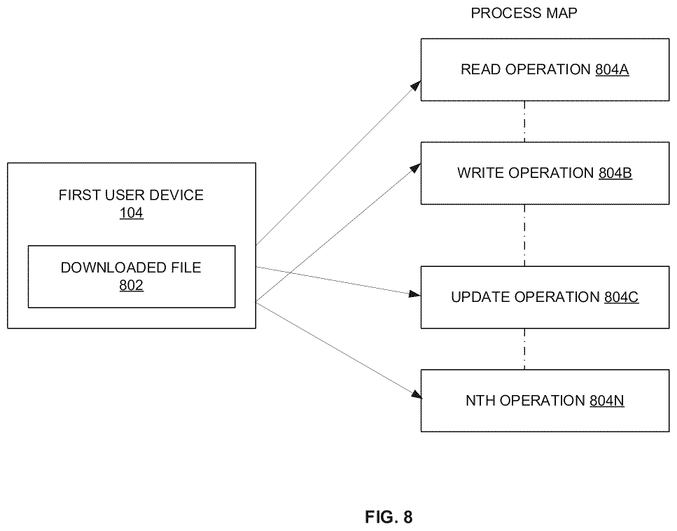

FIG. 8 is an exemplary diagram that illustrates a process map of a downloaded file in the first user device in accordance with some embodiments herein. The exemplary diagram depicts a first user device 104 and the downloaded file at 802 from the external device 106. The OSC server 114 intervenes when the downloaded file 802 generates one or more files on the first user device 104 to initiate CRUD operations 804A-N. In this process, the system 100 orchestrates a consolidated view of the parent file (i.e., the downloaded file) and its associated child processes (CRUD operations) as a unified operation. The OSC server 114 blocks the downloaded file, along with any additional files, and communicates this operation to the configured user devices. If the user 102 downloads a file that, upon execution, initiates the creation of new processes or on the file user's device to perform specific operations, these generated processes or files are considered spawned operations.

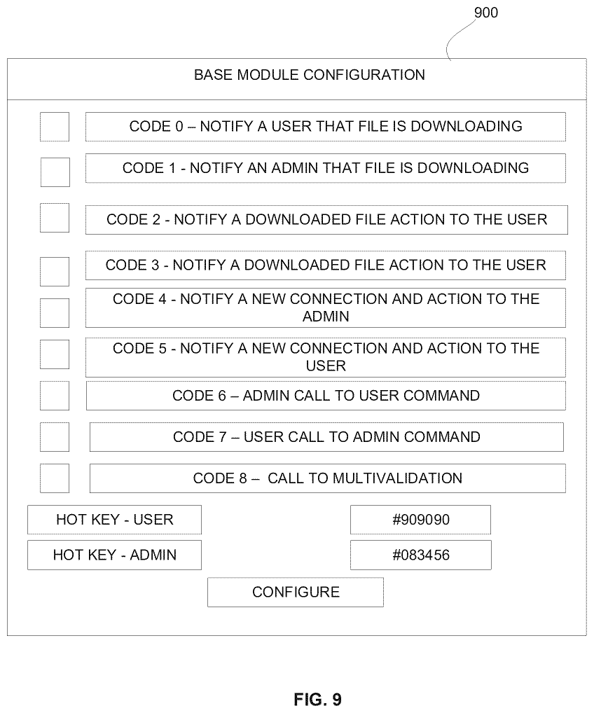

FIG. 9 is an exemplary user interface 900 view of the input-receiving submodule 302 of FIG. 2 which displays one or more action codes in accordance with some embodiments herein. The exemplary user interface 900 prompts the one or more action codes including the “code 0” to notify the user 102 that the file is downloading, the code 1 to notify the admin 110 that the file is downloading, for example, in a file-sharing platform, the users 102 may upload and download files. When the user 102 initiates a download, the OSC server 114 may utilize the “code 0” to notify the user 102 that the file is downloading. The notification may include details about a file, such as size and type, as well as an estimated time for completion, “code 2” represents the user 102 for notifying an action of downloaded files, for example, a cloud storage 602 platform allows the users to store and download files. When the user 102 initiates the file download, the OSC server 114 may utilize Code 1 to notify the admin 110 that the file is being downloaded. Thereby, the admin 110 may keep track of file downloads and ensure that there are no unauthorized or suspicious activities taking place. A “code 3” represents the admin 110 for notifying the action of the downloaded files. A “code 4” represents the admin 110 for notifying a new connection, and action, for example, when a new device is connected to the first user device 104, the OSC server 114 generates a notification for the admin 110 to inform that the new device has connected to the first user device 104. Thereby, the admin 110 can ensure that the new device is authorized and does not pose any security risks. Additionally, if the new device performs any actions that trigger the notification. The actions may be accessing sensitive data or running unauthorized applications, the admin 110 will be notified immediately. A “code 5” represents the user 102 for notifying the new connection and action. A “code 6” represents an admin call to the user command, (i.e.) the admin 110 may use the admin-call to the user command through the second user device 108 to instruct the user 102 to perform a specific action, such as to troubleshoot a problem, to update a setting, or to access the notification. A “code 7” may represent the user-call to admin command, (i.e.) the user 102 may use this command or request a specific action, such as to request assistance, report a problem, or access the notification. A “code 8” represents a multi-validation command that notifies multiple users and admins of downloading files and CRUD operations. The user 102 inputs a private key for both the user 102 and the admin 110 in the exemplary user interface 600 to enable first user device 104 to configure with OSC server 114.

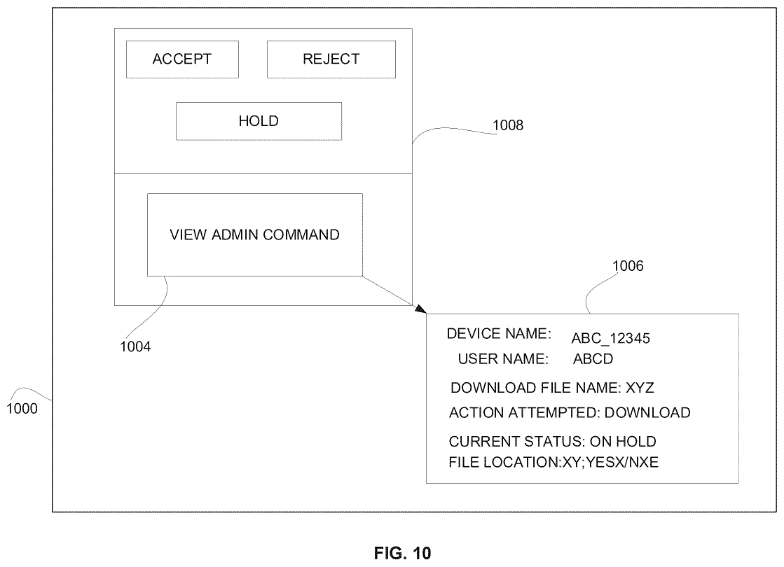

FIG. 10 is an exemplary user interface 1000 view of the first notification 1002 of downloading file that is sent to the user 102 of FIG. 1 in accordance with some embodiments herein. For example, if the user 102 selects the code 7, the OSC server 114 sends the first notification 1002 to the user 102, which means the admin 110 initiates a request to execute a command or perform an action that is performed by the user 102. The exemplary user interface 1000 depicts the first notification 1002 includes “Accept”, “reject” and “hold” options, and includes an option to a “view the admin command” 1004. If the user 102 or the admin 110 is notified about any downloads or any CRUD operation related to downloaded files initiated, the system 100 will prevent any downloads or any CRUD operation related to downloaded files from proceeding until the user 102 or the admin 110 issues a command to ACCEPT or REJECT or HOLD. For example, if the admin 110 selects the “view the user command” 1004, the user interface 1000 may display the first screenshot 1006 that includes a device name, user name, download file name, action attempted, a current status of the admin, a file location. For example, If the user 102 attempts to download the file from the external device 106 on their device, the OSC server 114 detects the file and blocks the download, and the notification is sent to the user 102 with options to accept, reject, or hold the file. The user 102 selects the “reject” option to prevent the file from being downloaded. The OSC server 114 logs the rejection and prevents any further attempts to download the file. Once the file download is rejected, the OSC server 114 rejects any further attempts to download the same file by keeping a record of the user 102 and the admin 110 actions. The record includes details such as the date, time, user/admin response, the file, and a reason for rejection.

For example, the admin 110 receives a request from the user 102 to download the file from the external device 106, the admin 110 initiates the request on the first user device 104. The OSC server 114 detects the download and sends a notification to the admin 110. The admin 110 reviews the notification and selects the “accept” option. The OSC server 114 proceeds to download the file securely to the first user device 104. The OSC server 114 suspends the download and provides additional details about the file if the admin 110 selects the “reject” option.

After file download, the OSC server 114 monitors the file for any the CRUD operation and prevents the first user device 104. The OSC server 114 immediately blocks actions if the file attempts to make unauthorized changes or delete sensitive data on the first user device 104. The user 102 is notified of the blocked actions and provided with options to allow or permanently block the file from performing any further actions.

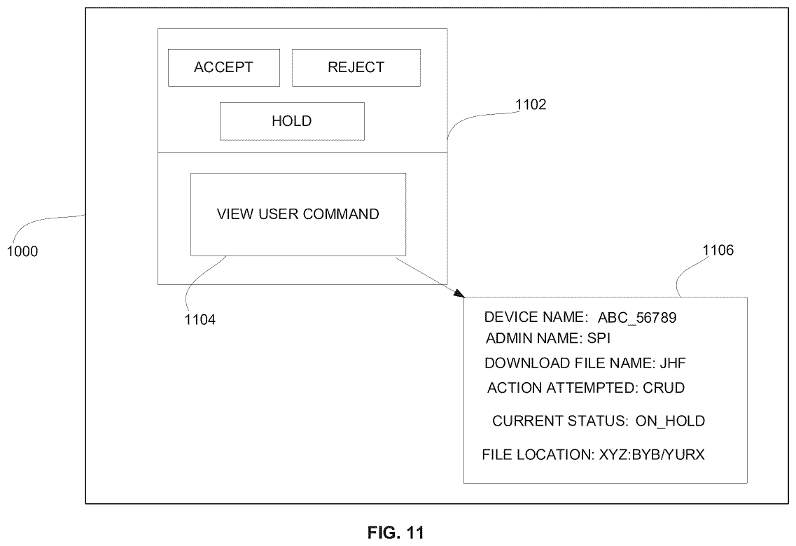

FIG. 11 is an exemplary user interface 1100 view of the second notification 1102 of downloading file that is sent to the admin of FIG. 1 in accordance with some embodiments herein. For example, if the user selects the code 6, the OSC server 114 sends the second notification 1102 which means the user 102 may be prompted to provide additional authentication before the requested action is carried out. The exemplary user interface 1100 depicts the second notification 1102 that includes “accept”, “reject” and “hold” options and includes the option to “view the admin command” 1104. For example, if the user 102 or the admin 110 selects the “view the admin command” 1104, the user interface 1100 may display the second screenshot 1106 that includes the device name, user name, download file name, action attempted, a current status of the admin, and a file location.

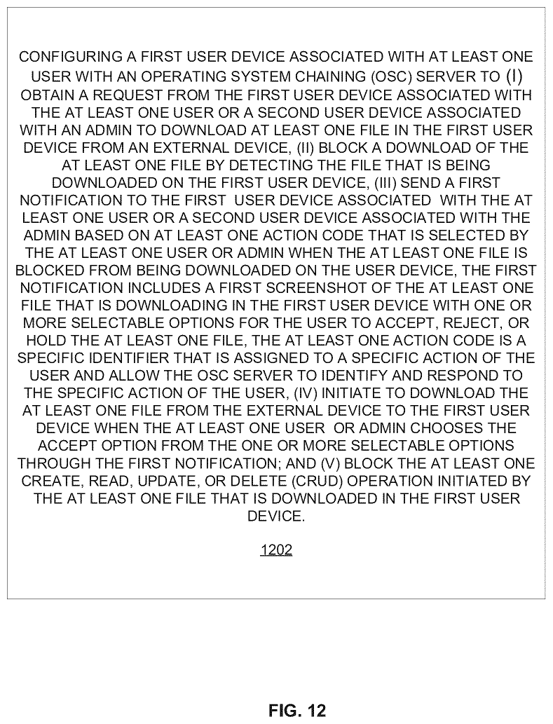

FIG. 12 is a flow diagram that illustrates a method for configuring a first user device to enable an automatic blocking of a downloaded file in the first user device when create, read, update, or delete (CRUD) operation is initiated by the downloaded file in accordance with some embodiments herein. At step 902, the method includes configuring the first user device associated with at least one user with an operating system chaining (OSC) server to (i) obtain a request from the first user device associated with the at least one user or the second user device associated with an admin to download at least one file in the first user device from an external device, (ii) block a download of the at least one file by detecting the file that is being downloaded on the first user device, (iii) send a first notification to the first user device associated with the at least one user or a second user device associated with the admin based on at least one action code that is selected by the at least one user or admin when the at least one file is blocked from being downloaded on the first user device. The first notification includes a first screenshot of the at least one file that is downloading in the first user device, with one or more selectable options for the user to accept, reject, or hold the at least one file. The at least one action code is a specific identifier that is assigned to a specific action of the user and allows the OSC server to identify and respond to the specific action of the user, (iv) initiate to download the at least one file from the external device to the first user device when the at least one user or admin chooses the accept option from the one or more selectable options through the first notification, (v) block the at least one create, read, update, or delete (CRUD) operation initiated by the at least one file that is downloaded in the first user device.

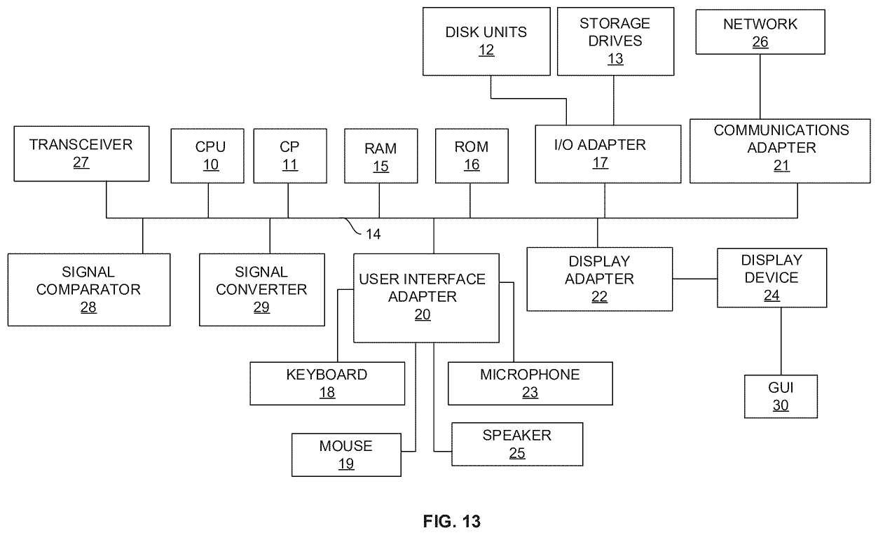

A representative hardware environment for practicing the embodiments herein is depicted in FIG. 13, with reference to FIGS. 1 through 12. This schematic drawing illustrates a hardware configuration of an OSC server 114 or computer system or computing device in accordance with the embodiments herein. The system includes at least one processing device CPU 10 that may be interconnected via system bus 14 to various devices such as random-access memory (RAM) 12, read-only memory (ROM) 16, and an input/output (I/O) adapter 18. The I/O adapter 18 can connect to peripheral devices, such as disk unit 38 and program storage devices 40 that are readable by the system. The system can read the inventive instructions on the program storage devices 40 and follow these instructions to execute the methodology of the embodiments herein.

The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A processor-implemented method for configuring a first user device to enable an automatic blocking of at least one downloaded file in the first user device when at least one create, read, update, or delete (CRUD) operation is initiated by the at least one downloaded file, wherein the method comprising,
configuring the first user device associated with at least one user with an operating system chaining (OSC) server to,
obtain a request from the first user device associated with the at least one user or a second user device associated with an admin to download at least one file in the first user device from an external device;
block a download of the at least one file by detecting the file that is being downloaded on the first user device;
send a first notification to the first user device associated with the at least one user or the second user device associated with the admin based on at least one action code that is selected by the at least one user or admin when the at least one file is blocked from being downloaded on the first user device, wherein the first notification comprises a first screenshot of the at least one file that is downloading in the first user device, with a plurality of selectable options for the user to accept, reject, or hold the at least one file, wherein the at least one action code is a specific identifier that is assigned to a specific action of the user and allow the OSC server to identify and respond to the specific action of the user;
initiate to download the at least one file from the external device to the first user device when the at least one user or admin chooses the accept option from the plurality of selectable options through the first notification; and
block the at least one create, read, update, or delete (CRUD) operation initiated by the at least one file that is downloaded in the first user device.

2. The processor-implemented method of claim 1, wherein the method comprises sending a second notification to the first user device of the at least one user or the second user device of the admin based on the at least one action code that is selected by the at least one user or admin when the at least one CRUD operation is blocked in the first user device, wherein the second notification comprises a second screenshot with the plurality of selectable options for the user to accept, reject, or hold the at least one CRUD operation of the at least one file that is downloaded in the first user device.

3. The processor-implemented method of claim 1, wherein the method comprises configuring the first user device associated with at least one user with the operating system chaining (OSC) server by,
receiving input from the at least one user through the first user device, wherein the input comprises at least one of a name of the user, the name of the admin, the mobile number of the user, the mobile number of the admin, a private key, or the at least one action code, wherein the at least one action code selected by the at least one user or admin from a plurality of action codes;
generating an encrypted globally unique identifier (GUID) for the input of the at least one user or admin;
sending the encrypted GUID to the first user device associated with the at least one user or the second user device of the admin based on the at least one action code selected by the user through a third notification; wherein the third notification comprises the plurality of selectable option codes, allowing the at least one user to choose at least one accept, reject or hold the third notification;
validating, by a first cryptone submodule of the first user device, the third notification to decrypt the GUID by analyzing whether the first user device is associated with the at least one user or the second user device is associated with the admin receives the third notification within range of time from the OSC server;
sending, by the first user device, the decrypted GUID along with an option code that is selected by the user from the plurality of selectable option codes to the OSC server;
mapping, by a second cryptone submodule of the OSC server, a position of the option code in the decrypted GUID, wherein the position may be accepted, hold, or rejected; and
configuring the first user device associated with at least one user or admin with the OSC server by adding the decrypted GUID with the first user device if the OSC server identifies the position as accepted.

4. The processor-implemented method of claim 3, wherein the method further comprises generating, using a randomization method, at least one first color code for the user and a second color code for the admin based on the encrypted GUID.

5. The processor-implemented method of claim 4, wherein the method comprises decrypting the GUID by automatically matching a third color code with the at least one first color code of the user or second color code of the admin, wherein the third color code is automatically generated using the randomization method by the first user device.

6. The processor-implemented method of claim of 3, wherein the encrypted GUID is generated based on a random selection of time zone alphanumeric with respective the mobile number of the at least one user or the admin, random color codes, and numbers, wherein the time zone is randomly selected from different time zones by the OSC server using a cryptone algorithm.

7. The processor-implemented method of claim 1, wherein the method comprises copying stored files in the first user device from an original space of the stored files to a kernel space of the first user device when the at least one CRUD operation is initiated by the at least one file that is downloaded in the first user device.

8. The processor-implemented method of claim 7, wherein the method comprises deleting the copy of the stored files from the kernel space of the first user device when the at least one user or admin the second notification through the first user device.

9. The processor-implemented method of claim 7, wherein the method comprises restoring the copy of the stored files from the kernel space of the first user device to the original space of the stored files in the first user device when the at least one user or admin rejects the second notification through the first user device.

10. A system for configuring a first user device to enable an automatic blocking of at least one downloaded file in the first user device when at least one create, read, update, or delete (CRUD) operation is initiated by the at least one downloaded file, wherein the system comprising,
an operating system chaining (OSC) server is communicatively configured to the first user device, wherein the OSC server comprises,
a memory comprises a set of instructions;
a processor that is configured to retrieve and execute the set of instructions from the memory and is configured to,
obtain a request from the first user device associated with the at least one user or the second user device associated with an admin to download at least one file in the first user device from an external device;
block a download of the at least one file by detecting the file that is being downloaded on the first user device;
send a first notification to the first user device associated with the at least one user (102) or the second user device associated with the admin based on at least one action code that is selected by the at least one user or admin when the at least one file is blocked from being downloaded on the first user device, wherein the first notification comprises a first screenshot of the at least one file that is downloading in the first user device, with a plurality of selectable options for the user to accept, reject, or hold the at least one file, wherein the at least one action code is a specific identifier that is assigned to a specific action of the user and allow the OSC server to identify and respond to the specific action of the user;
initiate to download the at least one file from the external device to the first user device when the at least one user or admin chooses the accept option from the plurality of selectable options through the first notification; and
block the at least one create, read, update, or delete (CRUD) operation initiated by the at least one file that is downloaded in the first user device.

11. The system of claim 10, wherein the processor is configured to send a second notification to the first user device of the at least one user or the second user device of the admin based on the at least one action code that is selected by the at least one user or admin when the at least one CRUD operation is blocked in the first user device, wherein the second notification comprises a second screenshot with the plurality of selectable options for the user to accept, reject, or hold the at least one CRUD operation of the at least one file that is downloaded in the first user device.

12. The system of claim 10, wherein the processor configures the first user device associated with at least one user with the operating system chaining (OSC) server by,
receiving input from the at least one user through the first user device, wherein the input comprises at least one of a name of the user, the name of the admin, the mobile number of the user, the mobile number of the admin, a private key, or the at least one action code, wherein the at least one action code selected by the at least one user or admin from a plurality of action codes;
generating an encrypted globally unique identifier (GUID) for the input of the at least one user or admin;
sending the encrypted GUID to the first user device associated with the at least one user or the second user device of the admin based on the at least one action code selected by the user through a third notification; wherein the third notification comprises the plurality of selectable option codes, allowing the at least one user to choose at least one accept, reject or hold the third notification;
validating, by a first cryptone submodule of the first user device, the third notification to decrypt the GUID by analyzing whether the first user device is associated with the at least one user or the second user device is associated with the admin receives the third notification within range of time from the OSC server;
sending, by the first user device, the decrypted GUID along with an option code that is selected by the user from the plurality of selectable option codes to the OSC server;
mapping, by a second cryptone submodule of the OSC server, a position of the option code in the decrypted GUID, wherein the position may be accepted, hold, or rejected; and
configuring the first user device associated with at least one user or admin with the OSC server by adding the decrypted GUID with the first user device if the OSC server identifies the position as accepted.

13. The system of claim 12, wherein the processor is configured to generate, using a randomization method, at least one first color code for the user and a second color code for the admin based on the encrypted GUID.

14. The system of claim 13, wherein the processor is configured to decrypt the GUID by automatically matching a third color code with the at least one first color code of the user or second color code of the admin, wherein the third color code is automatically generated using the randomization method by the first user device.

15. The system of claim of 12, wherein the encrypted GUID is generated based on a random selection of time zone alphanumeric with respective the mobile number of the at least one user or the admin, random color codes, and numbers, wherein the time zone is randomly selected from different time zones by the OSC server using a cryptone algorithm.

16. The system of claim 10, wherein the processor is configured to copy stored files in the first user device from an original space of the stored files to a kernel space of the first user device when the at least one CRUD operation is initiated by the at least one file that is downloaded in the first user device.

17. The system of claim 16, wherein the processor is configured to delete the copy of the stored files from the kernel space of the first user device when the at least one user or admin the second notification through the first user device.

18. The system of claim 16, wherein the processor is configured to restore the copy of the stored files from the kernel space of the first user device to the original space of the stored files in the first user device when the at least one user or admin rejects the second notification through the first user device.

19. One or more non-transitory computer-readable storage mediums storing one or more sequences of instructions, which when executed by one or more processors, cause a method for configuring a first user device to enable an automatic blocking of at least one downloaded file in the first user device when at least one create, read, update, or delete (CRUD) operation is initiated by the at least one downloaded file, wherein the method comprising,
configuring the first user device associated with at least one user with an operating system chaining (OSC) server to,
obtain a request from the first user device associated with the at least one user or a second user device associated with an admin to download at least one file in the first user device from an external device;
block a download of the at least one file by detecting the file that is being downloaded on the first user device;
send a first notification to the first user device associated with the at least one user or the second user device associated with the admin based on at least one action code that is selected by the at least one user or admin when the at least one file is blocked from being downloaded on the first user device, wherein the first notification comprises a first screenshot of the at least one file that is downloading in the first user device, with a plurality of selectable options for the user to accept, reject, or hold the at least one file, wherein the at least one action code is a specific identifier that is assigned to a specific action of the user and allow the OSC server to identify and respond to the specific action of the user;
initiate to download the at least one file from the external device to the first user device when the at least one user or admin chooses the accept option from the plurality of selectable options through the first notification; and
block the at least one create, read, update, or delete (CRUD) operation initiated by the at least one file that is downloaded in the first user device.
